(19) United States
(12) Patent Application Publication
(10) Pub. No.: US 2016/0272260 A1
(43) Pub. Date: Sep. 22, 2016

(54) Track Recoil System and Method of Installing

(71) Applicant: CATERPILLAR INC., Peoria, IL (US)

(72) Inventor: Joshua Nuechterlein, Washington, IL (US)

(73) Assignee: CATERPILLAR INC., Peoria, IL (US)

(21) Appl. No.: 14/658,887

(22) Filed: Mar. 16, 2015

(51) Int. Cl. B62D 55/30; B62D 55/32

(52) U.S. Cl. CPC B62D 55/30; B62D 55/32

(57) ABSTRACT

A recoil system for a track roller frame of a track assembly is provided including a spring, a track adjust cylinder and an end plate. A rear support member is connected to the end plate and a pivot shaft connecting member of the track roller frame. A track adjust piston is received in the track adjust cylinder. The spring is arranged with a first end abutting against the track adjust cylinder and a second end abutting against the end plate. The track adjust cylinder and the track adjust piston are movable in first and second directions in response to movement of an idler with movement of the track adjust cylinder in the second direction compressing the spring against the end plate. A front support assembly is configured to support the track adjust piston relative to the track roller frame while permitting movement of the track adjust piston in the first and second directions.

### TECHNICAL FIELD

This disclosure relates generally to track assemblies for machines and, more particularly, to a recoil system for a track assembly of a machine.

### BACKGROUND

Track type machines are used in a variety of applications in, for example, the construction, mining, agricultural and forestry industries. Track type machines utilize one or more track assemblies that include an endless track that extends around a plurality of rolling elements. In order to better allow the tracks of the machine to interact with variable loads encountered when the machine is being maneuvered over the ground including, for example, rocks or logs, the track assemblies may be equipped with a recoil system. A typical track recoil system may include a forward idler that is supported by a track roller frame assembly about which the track is mounted. The idler may be connected to a yoke that may slide fore and aft with respect to the track roller frame assembly in order to react to various loads that are transmitted from the track to the idler. The yoke in turn acts upon a biasing member that is compressed when the idler and yoke are pushed rearward relative to the track roller frame assembly. The spring then pushes back on the yoke and idler to recoil both toward their undisturbed operating configuration.

One example of such a recoil system is disclosed in U.S. Pat. No. 8,079,650 (“the '650 patent”). A problem with recoil systems such as disclosed in the '650 patent is that they can involve metal-to-metal contact between moving parts that can make the systems subject to wear. Some of the wear can be alleviated by the use of a lubricant, which must be periodically applied to the moving parts.

### SUMMARY

In one aspect, the disclosure describes a recoil system for a track assembly having a track roller frame with a pivot shaft connecting member for connecting to a pivot shaft of a machine frame and an idler movable relative to the track roller frame in opposing first and second directions. The recoils system includes a spring, a track adjust cylinder and an end plate. A rear support member has a first end connected to the end plate and a second end that is connectable to the pivot shaft connecting member. A track adjust piston is received in the track adjust cylinder. The spring is arranged with a first end abutting against the track adjust cylinder and a second end abutting against the end plate. The track adjust cylinder and the track adjust piston are movable in the first and second directions in response to movement of the idler with movement of the track adjust cylinder in the second direction compressing the spring against the end plate. A front support assembly is configured to support the track adjust piston relative to the track roller frame while permitting movement of the track adjust piston in the first and second directions. The front support assembly is connectable to the track roller frame. The track adjust cylinder is adapted to rotate with the first end of the spring relative to the track adjust piston as the spring compresses and extends in response to movement of the track adjust cylinder in the first and second directions and the second end of the spring is fixed against rotation relative to the end plate.

In another aspect, the disclosure describes a method of installing a recoil system in a track roller frame of a track assembly. The track roller frame has a pivot shaft connecting member for connecting to a pivot shaft of a machine frame and an idler support movable relative to the track roller frame in opposing first and second directions. The method includes the step of positioning a track adjust piston in engagement with the idler support. The track adjust piston is received in a track adjust cylinder with a spring with a first end abutting against the track adjust cylinder and a second end abutting against an end plate. The track adjust cylinder and the track adjust piston are movable in the first and second directions in response to movement of the idler support with movement of the track adjust cylinder in the second direction compressing the spring against the end plate. The track adjust cylinder is adapted to rotate with the first end of the spring relative to the track adjust piston as the spring compresses and extends in response to movement of the track adjust cylinder in the first and second directions and the second end of the spring is fixed against rotation relative to the end plate. A first end of a rear support member is connected to the end plate and a second end of the rear support member is connected to the pivot shaft connecting member of the track roller frame. The track adjust piston is supported relative to the track roller frame with a front support assembly configured to permit movement of the track adjust piston in the first and second directions. The front support assembly is connected to the track roller frame.

In yet another aspect, the disclosure describes a method of installing a recoil system in a track roller frame of a track assembly. The track roller frame has a pivot shaft connecting member for connecting to a pivot shaft of a machine frame and an idler support movable relative to the track roller frame in opposing first and second directions. The method includes the step of positioning a track adjust piston for engagement with the idler support. A track adjust cylinder and the track adjust piston are movable in the first and second directions in response to movement of the idler support with movement of the track adjust cylinder in the second direction compressing a spring against an end plate. A first end of a rear support member is connected to the end plate and a second end of the rear support member is connected to the pivot shaft connecting member of the track roller frame. The track adjust piston is supported relative to the track roller frame with a front support assembly configured to permit movement of the track adjust piston in the first and second directions. The front support assembly is connected to the track roller frame. The connection of the track adjust piston to the forward support assembly and the connection of the end plate to the rear support member are the only points of contact between the recoil system and the track roller frame.

### BRIEF DESCRIPTION OF THE DRAWINGS

FIG. 1 is a side view of an exemplary track type machine according to the present disclosure.

FIG. 2 is a partially cut away isometric view of a track assembly of the machine of FIG. 1.

FIG. 3 is a side sectional view of a portion of a track roller frame of the track assembly of FIG. 2.

FIG. 4 is an enlarged side sectional view of a recoil system of the track roller frame of FIG. 3.

FIG. 5 is an enlarged isometric view of a portion of an end plate of the recoil system of FIG. 4.

FIG. 6 is an enlarged isometric view of an exemplary rear support member of the recoil system of FIG. 4.

FIG. 7 is an enlarged isometric view of an exemplary front support member of the recoil system of FIG. 4.

FIG. 8 is a flow diagram illustrating an exemplary method of installing a recoil system in a track roller frame according to the present disclosure.

### DETAILED DESCRIPTION

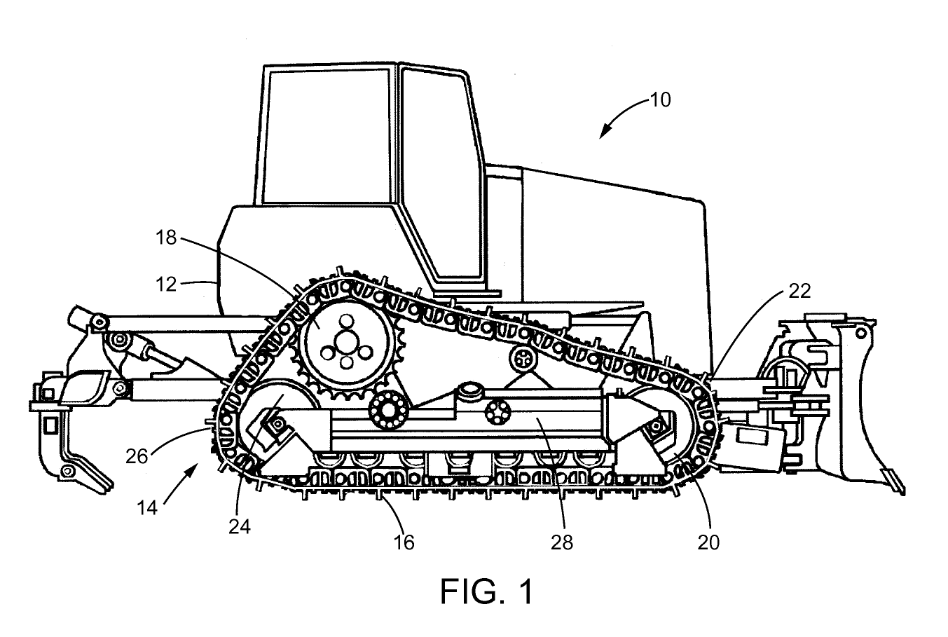

This disclosure generally relates to a track assembly for a machine and, more particularly, to a recoil system for a track assembly. An exemplary embodiment of a machine 10 is shown in FIG. 1. The machine 10 may be a mobile machine that performs some type of operation associated with an industry such as mining, construction, farming, transportation, forestry or any other industry known in the art. For example, the machine 10 may be a track-type tractor, as depicted in FIG. 1, having a frame 12 and a track assembly 14 supported on the frame 12. The track assembly 14 may include a ground engaging track 16 that may propel the machine 10 over a surface. In the exemplary embodiment shown in FIG. 1, identical track assemblies 14 may be provided on each side of the machine 10 (only one side is visible in FIG. 1). Although the track type machine 10 is illustrated as a track type tractor, those skilled in the art will appreciate that the present disclosure is equally applicable to any track type machine.

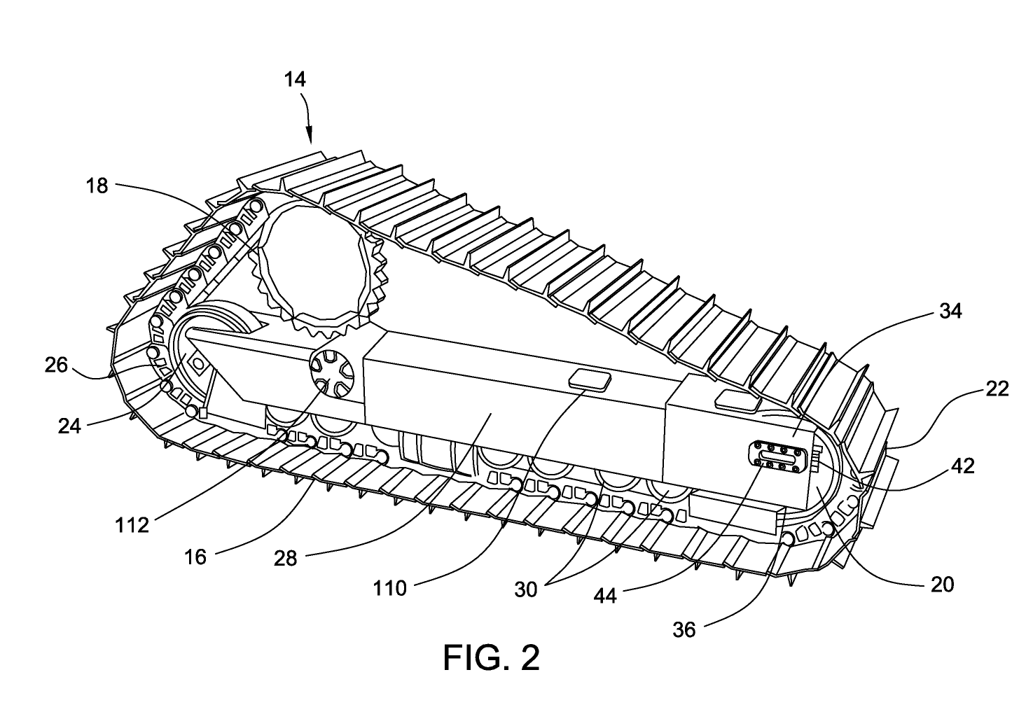

As shown in FIG. 2, the track assembly 14 may further include a driven sprocket 18 that may be coupled to a power source by way of, for example, a drive train (not shown) and configured to engage and drive the ground engaging track 16. The track assembly 14 may include a front idler 20 arranged at a front end 22 of the track assembly 14. The front idler 20 may comprise a rolling element that passively rolls against and helps support the track 16. As shown in the illustrated embodiment, the track assembly 14 may also include a rear idler 24 arranged at a rear end 26 of the track assembly 14. The front and rear idlers 20, 24 may be supported by a track roller frame 28 upon which the ground engaging track 16 may be mounted. The track roller frame 28 may further include a number of smaller rollers 30 configured to support and guide the ground engaging track 16. While in the illustrated embodiment the driven sprocket 18 is arranged generally above the track roller frame 28 near the rear end 26 of the track assembly 14, those skilled in the art will appreciate that the driven sprocket 18 may be arranged in other locations in the track assembly 14. For example, according to some embodiments, the driven sprocket 18 may be provided at the rear end 26 of the track assembly 14 in place of the rear idler 24.

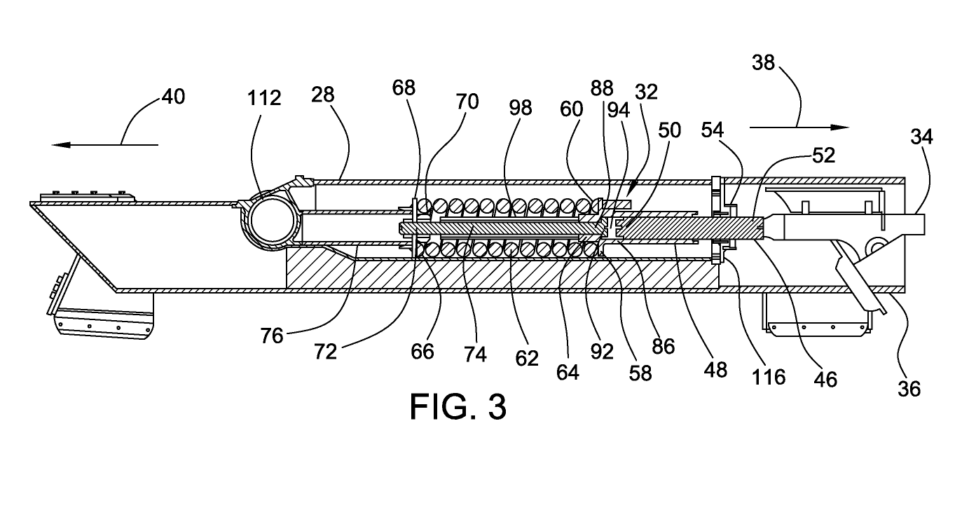

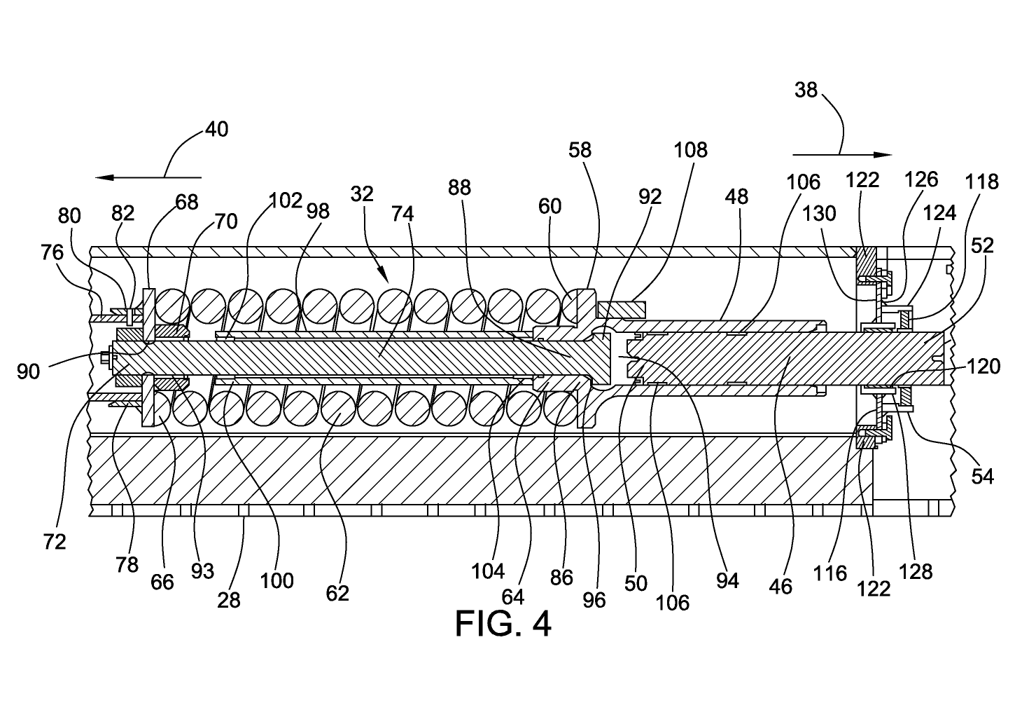

With reference to FIGS. 3 and 4, the track roller frame 28 may support a recoil system 32 that may be operably positioned between the front idler 20 and the track roller frame 28 so as to allow for relative movement of the front idler 20 relative to, in this case, the track roller frame 28, the rear idler 24 and the drive sprocket 18. More particularly, as shown in FIGS. 2 and 3, the recoil system 32 may include an idler support 34 at a front end 36 of the track roller frame 28 that is configured to rotatably support the front idler 20. For example, the idler support 34 may be configured as yoke. The idler support 34 may support the front idler 20 such that the front idler 20 may move in the forward direction 38 (i.e. toward the front end 22 of the track assembly 14) and the rearward direction 40 (i.e., toward the rear end 26 of the track assembly 14). For example, as shown in FIG. 2, the idler support 34 may include a keyway 42 in which a slide block 44 associated with the front idler 20 may slide in the forward and rearward directions 38, 40. Those skilled in the art will appreciate that the idler support 34 could have other configurations as well.

When the front idler 20 is pushed or driven in the rearward direction 40 such as when a load is applied to the track assembly 14, the idler support 34 may bear against a track adjust piston 46 of the recoil system 32. The track adjust piston 46 may be, at least partially, supported for longitudinal movement with respect to the track adjust piston 46 in the forward and rearward directions 38, 40 within a track adjust cylinder 48. More particularly, a rear portion 50 of the track adjust piston 46 may be arranged in the hollow interior of the track adjust cylinder 48 while a front portion 52 may be supported for movement in the forward and rearward directions 38, 40 by a front support assembly 54 as described further below.

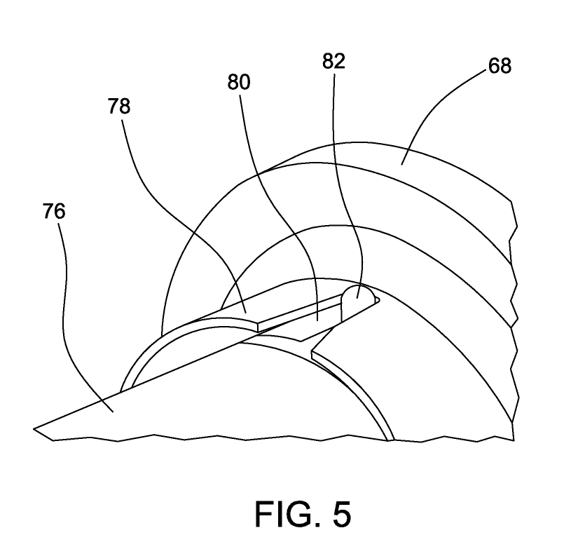

With reference to FIG. 4, the track adjust cylinder 48 may support a spring plate 58 that bears against a forward end 60 of a spring 62. The spring plate 58 may be integrated with the track adjust cylinder 48 into a single component. The track adjust cylinder 48 may further include a neck portion 64 that extends in the rearward direction 40 from the spring plate 58 and is received in the interior of and supports the forward end 60 of the spring 62. The spring 62 may be a compression spring that is configured to produce a biasing force in the forward direction 38 when compressed. A rear end 66 of the spring 62 may bear against an end plate 68 and be supported by a support collar 70 that extends around a rear end 72 of a recoil rod 74. The end plate 68 may be secured to a rear support member 76 that, in turn, is fixedly connected to the track roller frame 28 (see FIG. 3). As discussed further below, in one embodiment, the rear support member 76 may be configured as a tube. A neck 78 may also be connected to the end plate 68 and extend in the rearward direction 40 in surrounding relation to the rear support member 76. As shown in FIG. 5, this neck 78 may have a slot 80 or other opening therein that may receive a locking pin 82 that engages in a complementary opening in the rear support member 76. The locking pin 82 may fix the neck 78 and with it the end plate 68 against rotation relative to the rear support member 76 and the recoil rod 74. Thus, the end plate 68 may be adapted to be stationary in both the forward and rearward directions 38, 40 as well as fixed against rotation. Those skilled in the art will appreciate that other methods may be used to fix the end plate 68 against rotation and against movement in the forward and rearward directions 38, 40.

The rear end 72 of the recoil rod 74 may be supported in an opening 90 in the end plate 68 so as to allow movement of the recoil rod 74 in the forward and rearward directions 38, 40. The support collar 70 may extend in surrounding relation to the recoil rod 74 near the rear end 72 thereof. To facilitate sliding movement of the recoil rod 74 relative to the support collar 70, a bearing 93 may be interposed between the support collar 70 and the recoil rod 74 as shown in FIG. 4.

As shown in FIG. 4, the neck 78 and the spring plate 58 may be configured to support the spring 62 at the forward end 60 thereof and the support collar 70 and the end plate 68 may be configured to the support the rear end 66 of the spring 62 while the center portion of the spring 62 does not contact any other components of the recoil system 32 or the track roller frame 28. Additionally, the end plate 68 and the front support assembly 54 may support the recoil system 32 near either end thereof such that the center portion of the recoil system 32, including components thereof that move during operating of the recoil system such as the spring 62 and the track adjust cylinder 48, does not contact any other portion of the track roller frame 28.

A rear portion 86 of the track adjust cylinder 48 may be further configured to receive a forward end 88 of the recoil rod 74. The forward end 88 of the recoil rod 74 may have an enlarged head 92 that is larger than the interior passage in the track adjust cylinder 48 within which the recoil rod 74 is received. The track adjust piston 46, the track adjust cylinder 48 and the recoil rod 74 may be configured such that rearward movement of the track adjust piston 46 applies a force on the recoil rod 74 that moves the recoil rod 74 in the rearward direction 40.

In the illustrated embodiment, a chamber 94 is provided between the rear portion 50 of the track adjust piston 46 and the forward end 88 of the recoil rod 74. This chamber 94 may be filled, as discussed further below, by an incompressible fluid such as grease. With such a configuration, movement in the rearward direction 40 of the track adjust piston 46 may push through the incompressible fluid in the chamber 94 on the enlarged head 92 of the recoil rod 74. The enlarged head 92, in turn, may bear on a shoulder 96 in the interior of the track adjust cylinder 48 and thereby push the track adjust cylinder 48, and with it the spring plate 58, in the rearward direction 40 relative to the track roller frame 28. This rearward movement of the track adjust cylinder 48 and the spring plate 58 may bear on the spring 62 and compress it against the stationary end plate 68.

A stop tube 98 may extend in surrounding relation to the recoil rod 74 to limit rearward movement of the track adjust cylinder 48. More particularly, the stop tube 98 may extend in the rearward direction 40 from the rear portion 86 of the track adjust cylinder 48. The rear end 100 of the stop tube 98 may be spaced a distance from the support collar 70 when the spring 62 is in an uncompressed condition such as shown in FIG. 4. When, for example, a load is applied on the front idler 20 that causes the spring 62 to compress, the track adjust cylinder 48 pushes the stop tube 98 in the rearward direction 40. However, rearward travel of the stop tube 98 stops when it engages the collar 70 thereby stopping rearward movement of the track adjust cylinder 48 and further compression of the spring 62. Thus, the stop tube 98 may limit the travel of the front idler 20 in the rearward direction 40. The stop tube 98 may be supported near either end thereof on the recoil rod 74, such as by bearings. In the illustrated embodiment, as shown in FIG. 4, the stop tube 98 may be supported on the recoil rod 74 by a front bearing 104 and a rear bearing 102 that permit rotary movement of the stop tube 98 relative the recoil rod 74. Otherwise, however, the stop tube 98 does not contact the recoil rod 74. Additionally, the stop tube 98 may be configured and supported such that it extends through the interior of the spring 62 without coming into contact with the spring 62 as shown in FIG. 4.

As is known, the body of a spring rotates as it is compressed and extended. To accommodate such rotation, the rear end 66 of the spring 62 may bear against the stationary end plate 68 in such a manner that the rear end 66 of the spring 62 is fixed against rotation. In contrast, the track adjust cylinder 48 may be supported relative to the track roller frame 28 so as to be rotatable about the longitudinal axis of the track adjust cylinder relative to the track adjust piston 46. Thus, when the spring 62 compresses and rotates about its longitudinal axis, the force of the spring 62 on the spring plate 58 will rotate the track adjust cylinder 48 relative to the track adjust piston 46 which does not rotate. When the load on the front idler 20 is released, the spring 62 extends and rotates the track adjust cylinder 48 back to its original position relative to the track adjust piston 46 and the recoil rod 74. One or more wear bands 106 may be interposed between the track adjust piston 46 and the track adjust cylinder 48 to facilitate the rotary movement of the track adjust cylinder 48 relative to the track adjust piston 46. In the illustrated embodiment, two wear bands 106 are provided as shown in FIG. 4.

The recoil system 32 may be further configured such that the chamber 94 between the rear portion 50 of the track adjust piston 46 and the forward end 88 of the recoil rod 74 may be used to adjust the tension of the track 16. In particular, a valve assembly 108 may be provided on the track adjust cylinder 48 that may be used to fill the chamber 94 with a selected volume of grease, or other incompressible fluid, to adjust the effective distance between the recoil rod 74 and the idler support 34, thereby adjusting a forward position of the front idler 20, and consequently the tension in the track 16 that is mounted about the track roller frame 28. The valve assembly 108 may be configured to include various passageways to facilitate the addition or removal of grease from the chamber 94, as well as the ability to bleed gas from the chamber 94. For example, introducing additional grease into the chamber 94 may push the track adjust piston 46 in the forward direction 38 which will, in turn, move the idler support 34 in the forward direction 38. This may increase the tension on the track 16. As shown in the FIG. 2, the track roller frame 28 may include an access port 110 that may be used to access the valve assembly 108 on the track adjust cylinder 48. The ability of the track adjust cylinder 48 to rotate in opposite directions relative to the track adjust piston 46 as the spring 62 compresses and extends can ensure that the valve assembly 108 returns to a position aligned with the access port 110 when a load is removed from the front idler 20. For example, when a load is applied on the front idler 20 that causes the spring 62 to compress, the valve assembly 108 may rotate out of alignment with the access port 110. However, when the load is removed, the spring 62 will extend again and the track adjust cylinder 48 and the valve assembly 108 will rotate back into alignment with the access port 110.

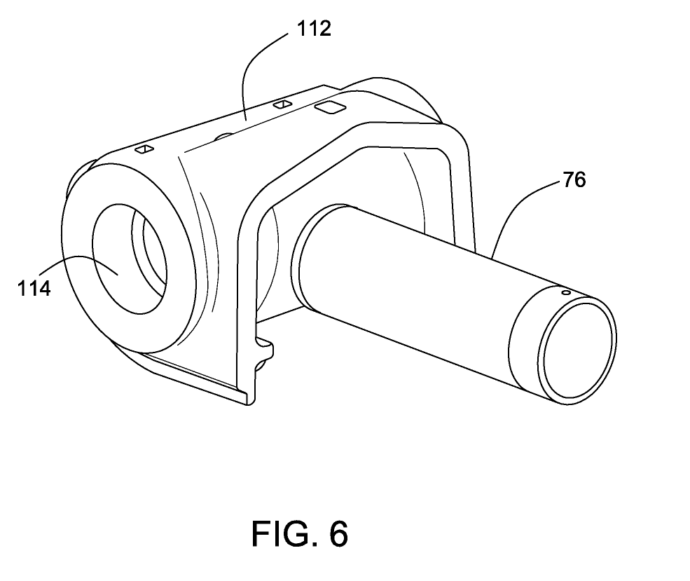

According to one embodiment, the rear support member 76 and the front support assembly 54 may be configured so as to allow the recoil system 32 to be retrofit into existing track roller frames 28. In particular, the rear support member 76, which as noted above may be a tube, may comprise a separate element that extends in the rearward direction 40 from the end plate 68 of the track roller frame 28 to a point where the rear support member 76 can be attached to the track roller frame 28. In particular, the rearward end of the rear support member 76 may be attached, such as by welding, to a connecting member of the track roller frame as shown in FIG. 6. In the illustrated embodiment, the connecting member may be a pivot shaft connecting member 112 that is configured to attach the track roller frame 28 to a pivot shaft on the frame 12 of the machine 10 that allows the track roller frame 28 to pivot relative to the frame 12. Connecting the recoil system 32 through the rear support member 76 to the pivot shaft connecting member 112 allows the loading of the recoil system 32 to be transferred to the pivot shaft and thereby to the frame 12 of the machine 10. In one embodiment, the pivot shaft connecting member 112 may be a casting with a bore 114 extending therethrough in a direction perpendicular to the longitudinal axis of the track roller frame 28 and within which the pivot shaft of the machine frame may be received.

The length of the rear support member 76 may be varied depending on the length of the track assembly 14 for the particular machine 10 in which the recoil system 32 is being installed. For example, the distance between the end plate 68 of the recoil system 32 and the pivot shaft connecting member 112 will be relatively shorter with relatively smaller track assemblies and the distance between the end plate 68 of the recoil system 32 and the pivot shaft connecting member 112 will be relatively longer with relatively larger track assemblies. Accordingly, a relatively shorter rear support member 76 may be used with relatively shorter track assemblies such as used with smaller machines while a relatively longer rear support member 76 may be used with the relatively longer track assemblies such as used with larger machines. Of course, the rear support member 76 may comprise structures other than a tube including, for example, solid members and assemblies of multiple components. Thus, the use of the term “member” herein is not meant to imply a structure having only a single component, but rather is meant to include structures or assemblies having multiple components.

As indicated above, the front support assembly 54 may be configured to support the recoil system 32 relative to the track roller frame 28 in such a manner that restrains movement of the track adjust piston 46 to the fore and aft directions relative to the track roller frame 28. In one embodiment, the front support assembly 54 may include a support plate 116 that supports a seal 118 and a bearing 120 for the track adjust piston 46. When being installed, the support plate 116 of the front support assembly 54 may attach to the track roller frame via a mounting bulkhead or flange 122 that extends from the inside wall of the track roller frame 28 as shown in FIG. 4. More specifically, the front support assembly 54 may connect, such as by bolts or other suitable fasteners, to the mounting flange 122 in the track roller frame 28 at a location rearward of the idler support 34. Other structures may be used to connect the front support assembly 54 to the track roller frame 28. For example, in a retrofit situation where the recoil system 32 is being used as a replacement on an existing machine 10, a flange or other connecting element may be added to the track roller frame 28 to provide a mounting location for the front support assembly 54 to the extent a suitable mounting location for the front support assembly does not already exist on the existing track roller frame.

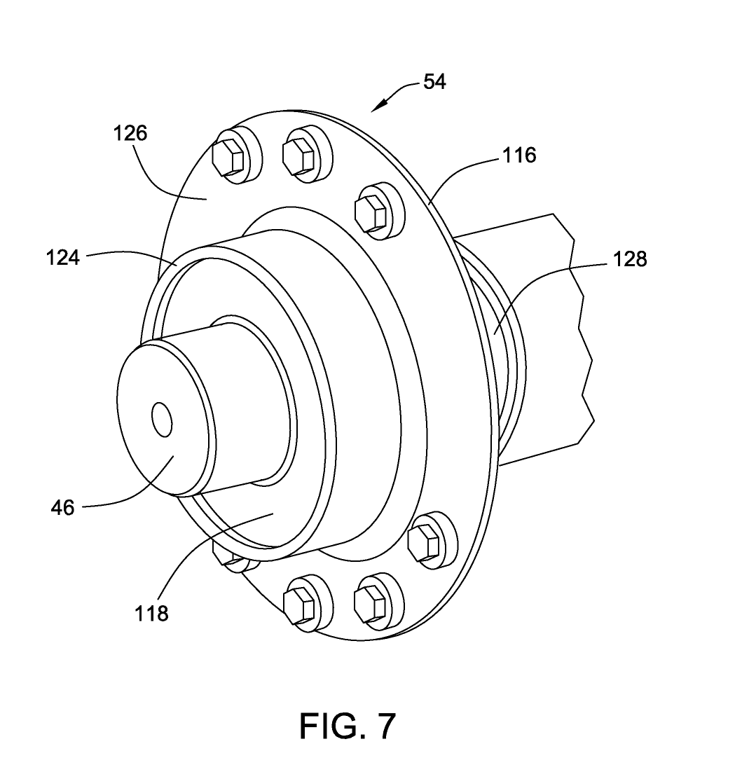

As shown in FIG. 7, a first tubular element 124 may be attached to the support plate for holding the seal 118 in position to sealingly engage the track adjust piston 46 (see FIG. 4). The first tubular element 124 may extend in the forward direction 38 from a forward side 126 of the support plate 116 in concentric relation to the track adjust piston 46. The seal 118 may be arranged in the first tubular element 124 so as to be in surrounding relation to the track adjust piston 46. The bearing 120 may be supported in a second tubular element 128, shown in FIG. 4, that extends in the rearward direction 40 from a rearward side 130 of the support plate 116 in concentric relation to the track adjust piston 46. The bearing 120 may be arranged in the second tubular member 128 so as to extend into engagement with the track adjust piston 46. The front support assembly 54 may have constructions other than that shown in the drawings so long as it supports the track adjust piston 46 relative to the track roller frame 28 while allowing the track adjust piston to move in the fore and aft directions.

### INDUSTRIAL APPLICABILITY

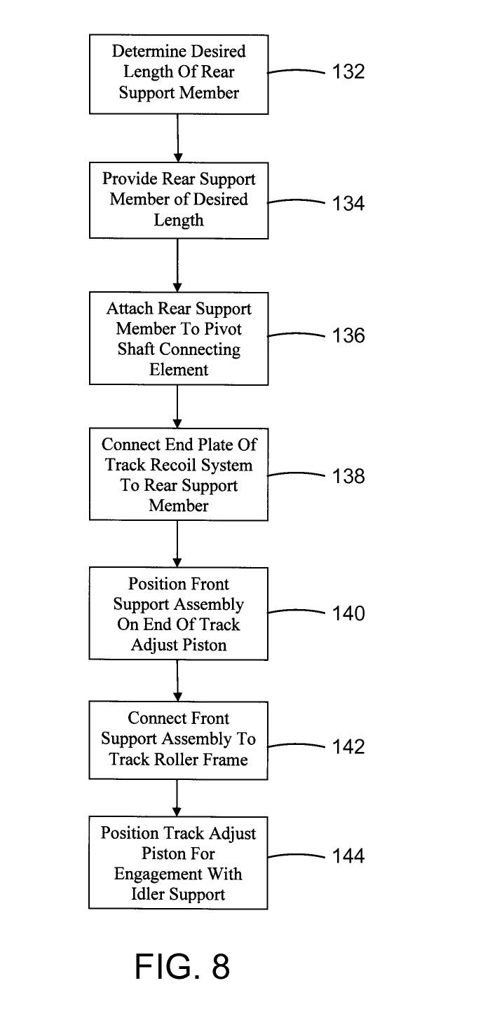

A flow diagram illustrating an exemplary method for installing the recoil system of the present disclosure into a track roller frame is provided as FIG. 8. This method may be used to install the recoil system into track roller frames of existing track assemblies and machines in retrofit situations. In step, 132, a desired length of the rear support member 76 is determined. This may be determined based on the length of the track roller frame 28 into which the recoil system 32 is to be installed. More particularly, the desired length of the rear support member 76 may be determined by determining the distance that will exist between the end plate 68 of the recoil system 32 and the pivot shaft connecting member 112 when the recoil system 32 is installed in the track roller frame 28. A rear support member 76 of the desired length is provided in step 134 such as, for example, by cutting the rear support member 76 to the desired length, by fabricating a rear support member 76 of the desired length or by selecting a rear support member of the desired length from a supply of rear support members of varying lengths.

In step 136, the rear support member 76 is connected to the pivot shaft connecting member 112. According to one example, the rear support member may be connected to the rear support member 76 by welding. The end plate 68 of the track recoil system 32 is connected to the rear support member 76 in step 138. In the embodiment illustrated in FIGS. 1-7, this connection may be accomplished by inserting the forward end of the rear support member 76 inside the hollow neck 78 that extends rearward from the end plate 68 (see, e.g., FIGS. 3 and 5).

In step 140, the front support assembly 54 is positioned on the end of the track adjust piston 46. This step may be accomplished by inserting the track adjust piston through the central bore defined by the first and second tubular elements 124, 128 attached to the support plate 116. In this way, the bearing 120 and seal 118 may be brought into operative engagement with the track adjust piston 46. In step 142, the front support assembly 54 is attached to the track roller frame 28. This may be accomplished by attaching the support plate 116 of the front support assembly 54 to the mounting flange 122 on the track roller frame 28 using suitable fasteners such as bolts. If a suitable mounting flange 122 is not already provided on the track roller frame 28, one may be added to the track roller frame in the appropriate location such as by welding. In step 144, the forward end of the track adjust piston 46 may be positioned for engagement with the idler support 34 associated with the front idler 20. The steps of the method shown in FIG. 8 can be performed in any order and are not limited to the order shown in FIG. 8.

The track assembly, and in particular the recoil system, of the present disclosure may be applicable to any track type machine, and especially those in need of a recoil capability. In addition, the present disclosure is applicable to those track machines that need some ability to adjust track tension, which may vary due to normal wear in the track, underlying rollers, idlers and sprockets. In particular, the recoil system may be operable to relieve tension on the track when rocks or other debris may become trapped between idlers or sprocket and track. When the tension on the track is relieved the recoil system may restore the track assembly back to a normal operating condition. Additionally, the recoil system may allow the tension on the track during normal operating conditions to be adjusted by adding or removing an incompressible fluid such as grease from a grease chamber provided in the recoil system.

Except for the grease provided in the grease chamber, the recoil system may otherwise be free of lubricant. In particular, the recoil system may be supported at either end such that the middle of the of the recoil system does not come into contact with the track roller frame. As there are no points of metal-to-metal contact other than the supports at either end of the recoil system, wear may be reduced and lubricant need not be provided. The spring, the stop tube and the recoil rod may also be supported relative to each other such that metal-to-metal contact is minimized. By eliminating the need to lubricate points of metal-to-metal contact, the recoil system of the present disclosure may need less maintenance as well as be less costly to maintain.

The support of the spring in which one end of the spring is fixed against rotation during compression and extension of the spring while the end of the spring bears against the track adjust cylinder and rotates along with the track adjust cylinder also helps reduce the amount of metal-to-metal contact and the need for lubrication. Additionally, the rotation of the track adjust cylinder helps ensure that the valve assembly is aligned with the access port when the spring is uncompressed. This may ease access to the valve assembly during maintenance operations.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A recoil system for a track assembly having a track roller frame with a pivot shaft connecting member for connecting to a pivot shaft of a machine frame and an idler movable relative to the track roller frame in opposing first and second directions, the recoil system comprising:
a spring;
a track adjust cylinder;
an end plate;
a rear support member having a first end connected to the end plate and a second end that is connectable to the pivot shaft connecting member;
a track adjust piston received in the track adjust cylinder, the spring being arranged with a first end abutting against the track adjust cylinder and a second end abutting against the end plate, the track adjust cylinder and the track adjust piston being movable in the first and second directions in response to movement of the idler with movement of the track adjust cylinder in the second direction compressing the spring against the end plate; and
a front support assembly configured to support the track adjust piston relative to the track roller frame while permitting movement of the track adjust piston in the first and second directions, the front support assembly being connectable to the track roller frame;
wherein the track adjust cylinder is adapted to rotate with the first end of the spring relative to the track adjust piston as the spring compresses and extends in response to movement of the track adjust cylinder in the first and second directions and wherein the second end of the spring is fixed against rotation relative to the end plate.

2. The recoil system of claim 1 wherein the rear support member comprises a tube.

3. The recoil system of claim 1 wherein the connection of the track adjust piston to the forward support assembly and the connection of the end plate to the rear support member are the only points of contact between the recoil system and the track roller frame.

4. The recoil system of claim 1 further including a recoil rod a first portion of which is received in the track adjust cylinder and wherein the recoil rod is adapted to move in the first and second directions in response to movement of the idler.

5. The recoil system of claim 4 wherein a chamber is defined in the track adjust cylinder between an end of the recoil rod and an end of the track adjust piston, the chamber being filled with an incompressible fluid.

6. The recoil system of claim 1 wherein the front support assembly includes a bearing that engages with the track adjust piston and a seal that engages with the track adjust piston, the bearing and seal being supported by a support plate.

7. The recoil system of claim 6 wherein the support plate is connectable to a flange on the track roller frame.

8. The recoil system of claim 4 further including a stop tube arranged in surrounding relation to the recoil rod and wherein a second portion of the recoil rod and the stop tube extend through the spring and the stop tube is supported on the recoil rod on bearings which are the only points of contact between the recoil rod and the stop tube and wherein the stop tube does not contact the spring.

9. The recoil system of claim 1 wherein the only points of contact between the track adjust cylinder and the track adjust piston are a plurality of wear bands interposed between the track adjust cylinder the track adjust piston.

10. A method of installing a recoil system in a track roller frame of a track assembly, the track roller frame having a pivot shaft connecting member for connecting to a pivot shaft of a machine frame and an idler support movable relative to the track roller frame in opposing first and second directions, the method comprising:
positioning a track adjust piston in engagement with the idler support, the track adjust piston being received in a track adjust cylinder with a spring with a first end abutting against the track adjust cylinder and a second end abutting against an end plate, the track adjust cylinder and the track adjust piston being movable in the first and second directions in response to movement of the idler support with movement of the track adjust cylinder in the second direction compressing the spring against the end plate, wherein the track adjust cylinder is adapted to rotate with the first end of the spring relative to the track adjust piston as the spring compresses and extends in response to movement of the track adjust cylinder in the first and second directions and wherein the second end of the spring is fixed against rotation relative to the end plate;
connecting a first end of a rear support member to the end plate and a second end of the rear support member to the pivot shaft connecting member of the track roller frame;
supporting the track adjust piston relative to the track roller frame with a front support assembly configured to permit movement of the track adjust piston in the first and second directions; and
connecting the front support assembly to the track roller frame.

11. The method of claim 10 further including the steps of:
determining a desired length of the rear support member based on a length of the track roller frame; and
providing a rear support member of the desired length.

12. The method of claim 10 wherein the rear support member comprises a tube.

13. The method of claim 10 wherein the step of supporting the track adjust piston with the front support assembly includes supporting a bearing that engages with the track adjust piston.

14. The method of claim 13 wherein the step of supporting the track adjust piston with the front support assembly includes supporting a seal that engages with the track adjust piston.

15. The method of claim 10 wherein the step of connecting the front support assembly to the track roller frame includes connecting the front support assembly to a flange on the track roller frame.

16. A method of installing a recoil system in a track roller frame of a track assembly, the track roller frame having a pivot shaft connecting member for connecting to a pivot shaft of a machine frame and an idler support movable relative to the track roller frame in opposing first and second directions, the method comprising:
positioning a track adjust piston for engagement with the idler support, a track adjust cylinder and the track adjust piston being movable in the first and second directions in response to movement of the idler support with movement of the track adjust cylinder in the second direction compressing a spring against an end plate;
connecting a first end of a rear support member to the end plate and a second end of the rear support member to the pivot shaft connecting member of the track roller frame;
supporting the track adjust piston relative to the track roller frame with a front support assembly configured to permit movement of the track adjust piston in the first and second directions; and
connecting the front support assembly to the track roller frame wherein the connection of the track adjust piston to the forward support assembly and the connection of the end plate to the rear support member are the only points of contact between the recoil system and the track roller frame.

17. The method of claim 16 further including the steps of:
determining a desired length of the rear support member based on a length of the track roller frame; and
providing a rear support member of the desired length.

18. The method of claim 16 wherein the rear support member comprises a tube.

19. The method of claim 16 wherein the step of supporting the track adjust piston with the front support assembly includes supporting a bearing that engages with the track adjust piston.

20. The method of claim 16 wherein the step of supporting the track adjust piston with the front support assembly includes supporting a seal that engages with the track adjust piston.
